(19) United States
(12) Patent Application Publication
(10) Pub. No.: US 2014/0033951 A1
(43) Pub. Date: Feb. 6, 2014

(54) ASPHALT MIXTURE WITHOUT VIRGIN BITUMEN BASED ON RECYCLED MATERIALS

(71) Applicant: LAFARGE, Paris (FR)

(72) Inventors: Mohsen Ech, Saint Quentin Fallavier (FR); Patrick Tintillier, Saint Quentin Fallavier (FR); Hassan Baaj, Saint Quentin Fallavier (FR); Nicolas Richard, Saint Quentin Fallavier (FR)

(73) Assignee: LAFARGE, Paris (FR)

(21) Appl. No.: 13/952,056

(22) Filed: Jul. 26, 2013

(30) Foreign Application Priority Data
Jul. 31, 2012 (FR) 1257449

(51) Int. Cl. C08K 5/101

(52) U.S. Cl. CPC C08K 5/101
USPC 106/279

(57) ABSTRACT

An asphalt mixture includes bitumen partially or in totality proceeding from construction materials, the bitumen having been regenerated using a fatty acid ester which is obtained from esterified vegetable oil.

### CROSS-REFERENCE TO RELATED APPLICATIONS

This application claims priority to French Patent Application No. 1257449 filed Jul. 31, 2012. The content of this application is incorporated herein by reference in its entirety.

### FIELD

The present invention relates to a asphalt mixture as well as to a process for preparation of this mixture.

### BACKGROUND

Bituminous binders are used in many applications, but more particularly to produce bituminous mixes used as surfacings for roads or to ensure roof water-proofness.

A known problem of bituminous mixtures is that the bitumen comprised in bituminous mixtures is obtained from petroleum, which is a non-renewable product and is becoming more and more expensive. It has therefore become interesting, for economic and environmental reasons, to recycle construction materials comprising bitumen in order to reuse this bitumen. For example, a known solution is to recycle shingles or reclaimed asphalt pavement of bituminous road surfacing. Bitumen contained in these recycled materials is known to be able to partially replace virgin bitumen in bituminous mixtures. The incorporation of shingles in bituminous mixtures is also a known solution, which reduces the quantity of virgin bitumen in bituminous mixtures.

A known problem for this incorporation of such construction materials in a asphalt mixture is that it is sometimes necessary to add additives to allow the hardened bitumen to resume its role as a binder. These additives are generally called rejuvenating oils.

However, these rejuvenating oils generally come from petroleum residue or have a carbon-chemical origin. During the production of the bituminous mixture, during its implementation and during its road usage, these oils completely or partially evaporate. The additives progressively disperse in the atmosphere inducing pollution of the atmosphere and contributing to a greenhouse effect. Furthermore, they most often contain polycyclic aromatic compounds, some of which at least, are known to be mutagenic, and therefore toxic. The use of these oils contributes to the depletion of fossil resources.

In order to meet user requirements, it has become necessary to find a more efficient means to reuse the bitumen contained in such construction materials as shingles.

### SUMMARY

Therefore, in an aspect of the invention, a problem which the invention seeks to solve is to provide a new adapted means of reusing the bitumen contained in such construction materials as shingles.

Unexpectedly, the inventors have shown that it is possible to use a fatty acid ester, obtained from esterified vegetable oil to reuse bitumen in construction materials, thus making it possible to partially or in totality substitute virgin bitumen with this bitumen.

With this aim, an embodiment of the present invention provides an asphalt mixture comprising bitumen completely or partially proceeding from construction materials, this bitumen having been regenerated using a fatty acid ester obtained from esterified vegetable oil.

### DETAILED DESCRIPTION

An embodiment of the present invention seeks to provide new bituminous mixtures which have one or more of the following characteristics:
A drop in production temperatures. The mixture according to an embodiment of the invention can indeed be produced at lower temperatures than typical temperatures in this field, in particular at temperatures less than 145° C. This results in significant energy savings, a reduction of emissions of greenhouse gases and it also improves work conditions for the operators;
Excellent resistance to rutting, ensuring anti-rutting material, in particular for subgrades with long service lives;
The fatty acid esters are not toxic for their users or for soils, subsoils and the environment, and they are biodegradable;
The fatty acid esters may be obtained by transesterification of vegetable oils, which are renewable products that do not come from petroleum derivatives;
Strict protection measures against fire during storage and during transport are not required when additives are used in the mixture according to an embodiment of the invention, given that the high flash point of fatty acid esters, is within the order of 170 to 200° C., instead of generally 50 to 95° C. for rejuvenating oils of petroleum or carbochemical origins;
A decrease of production costs;
The asphalt mixture according to an embodiment of the invention does not contribute to the depletion of fossil resources due to the fact that it does not use virgin bitumen, and that it can reduce the consumption of aggregates;
Upgrading waste materials, which contributes to better management of construction waste.

An embodiment of the invention relates to a asphalt mixture comprising at least
bitumen partially or in totality proceeding from construction materials;
a fatty acid ester, which is obtained from esterified vegetable oil.

The asphalt mixture according to an embodiment of the invention comprises bitumen proceeding partially or in totality from construction materials.

The asphalt mixture according to an embodiment of the invention comprises bitumen proceeding or extracted partially or in totality from construction materials.

The suitable construction materials for the asphalt mixture according to an embodiment of the present invention may be road surfacings, shingles, water-proof linings, any waste material comprising bitumen or mixtures thereof.

In an embodiment, the suitable construction materials for the asphalt mixture according to an embodiment of the present invention is a second-used material or a waste material.

For example, in an embodiment, the construction material comprising bitumen may be a waste construction material that is mixed with a fatty acid ester, which is obtained from esterified vegetable oil. The waste construction material may include a previously used construction material (e.g. used or aged shingles) and/or a defective construction material (e.g. shingles that are found defective during manufacturing). In an embodiment, the waste construction material is collected at a first location (e.g. asphalt in a road), then processed (e.g. ground to a desired size) and then mixed with the fatty acid ester and optional additional materials to form a new asphalt mixture. The asphalt mixture can then be used at a second location that is different from the first location. Moreover, the asphalt mixture thus obtained may be used for a completely different application than that of the original construction material. For example, it is envisioned that used shingles and/or defective shingles (for example shingles that are found defective during manufacturing) may be mixed with the fatty acid ester along with optional additional materials to form an asphalt mixture that could be used for road applications. Optionally, the shingles may be ground or crushed to a desired size before being mixed or put in contact with the fatty acid ester. Accordingly, in an embodiment, it will be appreciated that the new asphalt mixture thus obtained differs from an asphalt product that would be treated or processed directly on site (i.e. at a location where the asphalt product is originally located for a particular use) with a fatty acid ester. For example, in an embodiment, the new asphalt mixture thus obtained differs from a asphalt product present at a particular location, e.g. a road, and for a particular use that would be contacted with a fatty acid ester at that particular location. Moreover, in an embodiment, it will be appreciated that the bitumen in the new asphalt mixture is not prealably extracted from the collected waste construction material. Rather, the entire collected waste construction material comprising bitumen and non-bitumen material(s) is mixed with a fatty acid ester and one or more optional materials to form the new asphalt mixture. Accordingly, in an embodiment, the new asphalt mixture not only includes the bitumen of the waste construction product but also additional non-bitumen material(s) of the waste construction product. If the waste construction material is a shingle, the non-bitumen material(s) includes various materials that are used to manufacture a shingle. By virtue of not extracting the bitumen from the waste construction material, it is possible to significantly lower the costs for manufacturing the new asphalt mixture and to limit the production of additional waste materials, which is greatly beneficial. In addition, it has been found that the use of the entire collected waste construction material comprising bitumen and non-bitumen material(s) to form the new asphalt mixture provides a better asphalt product as opposed to an asphalt product in which the bitumen would be prealably extracted from the collected waste construction material.

In an embodiment, there is provided an asphalt mixture comprising:

a crushed waste construction material comprising bitumen and a non-bitumen material; and

a fatty acid ester, which is obtained from esterified vegetable oil. In an embodiment, the waste construction material originates from a construction material that is manufactured for a first application. For example, the construction material may be shingles. The shingles include bitumen and a non-bitumen material. The mixture product comprising the waste construction material can be used for a second application (e.g. road surfacing) that is different from the first application.

In an embodiment, there is provided an asphalt mixture made by a method comprising:

processing a waste construction material and/or previously used construction material comprising bitumen and a non-bitumen material to form a processed construction material, and

mixing or contacting the processed construction material with a fatty acid ester, which is obtained from esterified vegetable oil, to form the asphalt mixture.

In an embodiment, the processing of the method comprises grinding or crushing the waste construction material to a desired size before mixing or contacting the processed waste construction material with the fatty acid ester.

In an embodiment, the method includes collecting and/or extracting the waste construction material from a first ,location that is different from a location where the asphalt mixture is to be used.

In an embodiment, there is provided a method comprising:

preparing an asphalt mixture by mixing at least a waste construction material comprising bitumen and a non-bitumen material with a fatty acid ester, which is obtained from esterified vegetable oil, wherein the waste construction material is a waste product of a construction product originating from a first location; and

applying the asphalt mixture to a second location different from the first location to form an asphalt product that is different from the construction product.

In an embodiment, shingles are the suitable construction material for the asphalt mixture. Such shingles may come from waste material of roof shingle production plants (i.e. these are defective shingles); in this case it is new material, not yet used as shingles or such shingles may come from roof renovations; in this case it is used material, Used shingles are indeed submitted to substantial alterations over time due to the photochemical action of light, to oxidation by oxygen in the air, to the evaporation or dissolution of compounds in water, to biodegradation by micro organisms. Their aging results in harder and harder products which become breakable.

According to a variant, all the bitumen of the asphalt mixture according to an embodiment of the present invention comes from shingles.

In an embodiment, the asphalt mixture does not comprise or is devoid of virgin bitumen.

The asphalt mixture according to an embodiment of the invention comprises at least one fatty acid ester obtained from esterified vegetable oil. The asphalt mixture according to an embodiment of the invention may comprise a mix of different esters.

Without being bound by theory, it is believed that the bitumen in shingles will be modified or softened by the action of the fatty acid ester.

The fatty acid ester used in the asphalt mixture according to an embodiment of the invention is obtained by esterification of vegetable oil, this oil may be pure or it may be a mix of oils of different origins. It may also be waste oils or used oils.

Vegetable oils are generally the result of grinding grains. They come chemically in the form of triglycerides, which is to say triesters resulting from the condensation of three molecules of fatty acids and one molecule of glycerol. Fatty acids may have one or more double carbon-carbon bonds of variable numbers, depending on the plant the oil comes from. The fatty acids and the corresponding esters have a redox potential which depends on the number of double bonds and their closeness to each other in the hydrocarbon chain. This redox potential can be measured by the iodine number, and is expressed by oxygen-induced polymerisation, resulting in solidification and hardening. The iodine index gives the degree of unsaturation of a fatty substance: this is the mass of iodine, expressed in grams, which is consumed on 100 g of a fatty substance during an addition reaction.

In an embodiment, it is desirable that the esterified vegetable oil used in the asphalt mixture according is linseed oil, walnut oil, poppy seed oil, soybean oil, sunflower oil, rapeseed oil, maize oil, peanut oil, olive oil, castor oil, coconut oil, palm oil or mixtures thereof.

In an embodiment, the esterified vegetable oil used in the asphalt mixture is soybean oil.

The vegetable oil is esterified in order to obtain fatty acid esters by a transesterification reaction between a triglyceride and an alcohol. The esterification reaction may be a transesterification reaction of an ester with an alcohol, generally in the presence of an alkali catalyst, for example sodium hydroxide.

The fatty acid ester obtained from esterified oil used according to an embodiment of the invention may be obtained by the esterification of a vegetable oil, which is hydrolyzed beforehand. In this case, the vegetable oil is hydrolyzed in order to obtain glycerol and a mixture of fatty acids. Fractional distillation may then be carried out to separate the fatty acids. Then, the fatty acids are esterified.

In an embodiment, the fatty acid ester used in the asphalt mixture is obtained from the esterification of soybean oil.

In an embodiment, the esterified vegetable oil used in the asphalt mixture may comprise a mixture of saturated fatty acid esters and unsaturated fatty acid esters. This mixture may comprise esters of unsaturated fatty acids (C18 to C22), for example, oleic acid esters, linoleic acid esters, linolenic acid esters, arachidonic acid esters, erucic acid esters or mixtures thereof. This mixture may comprise esters of saturated fatty acids (C12 to C18), for example, lauric acid esters, myristic acid esters, palmitic acid esters, stearic acid esters or mixtures thereof.

The asphalt mixture according to an embodiment of the invention may also comprise sand or aggregates, in particular those generally used to make roads and road surfacings, in particular those according to the French NF 18-545 Standard of February 2004 and the European NF EN 13043 Standard of August 2003. They may also be those described in the American ASTM D448-08, ASTM D242/D242M-09, ASTM D692/D692M-09 or ASTM D1073-11 Standards.

An embodiment of the invention also relates to a process for production of a bituminous mixture, in particular an asphalt mixture according to an embodiment of the invention, comprising the following steps:

i) reducing the size of the construction materials comprising bitumen;

ii) combining the construction materials with a fatty acid ester obtained from esterified vegetable oil;

iii) combining the mixture obtained in step ii) with pre-heated aggregates.

The reduction in size of the construction materials comprising bitumen in step (i) may be carried out by any means, and in particular by grinding, crushing or shredding. This reduction in size may result in a change of shape of the material. Construction materials, in particular shingles may be mechanically crushed using industrial crushers, for example jaw crushers, gyratory crushers or crushers from Rotochopper Inc.

According to a variant, the reduction in size in step (i) is a crushing step followed by a grinding step. In this case, the crusher is used to sufficiently reduce the size of the material so that it may be transformed into finer particles in a grinder.

Beneficially, the reduction in size of the construction materials comprising bitumen in step (i) can mix the materials more homogenously.

In an embodiment, the reduction in size of the construction materials comprising bitumen in step (i) makes it possible to adapt the size of the materials to the size required for the target bituminous mixture.

The combining of the construction materials in step (ii) with the fatty acid ester may be carried out in several manners. All or part of the fatty acid ester may be added to the construction materials. This step may be carried out one or more days before step (iii). Moreover, it will be appreciated that the combining step (ii) is performed without prealably extracting the bitumen from the construction materials. Accordingly, the construction materials not only include the bitumen but also non-bitumen material(s).

The combining of the construction materials in step (iii) with the pre-heated aggregates may be carried out by any means, devices or apparatuses.

The aggregates of the process according to an embodiment of the invention are pre-heated. The aggregates are submitted to a thermal treatment. They are heated to a temperature generally of 80 to 145° C. Once the aggregates are pre-heated, they may then be added to the cold or lukewarm construction materials.

The construction materials may also be submitted to a thermal treatment at a temperature not exceeding 110° C.

Beneficially, the process according to an embodiment of the invention is used at a temperature less than or equal to 145° C., for example, in an embodiment, less than or equal to 142° C.

If virgin bitumen is added to the process according to an embodiment of the invention, this virgin bitumen may also be heated.

According to a variant, it is also possible that the construction materials are first combined with the pre-heated aggregates, then all or part of the fatty acid ester is added to this mixture. According to this variant of the process according to an embodiment of the invention, the process comprises the following steps:
i) reducing the size of the construction materials comprising bitumen;
ii) combining the construction materials with the pre-heated aggregates;
iii) combining the mixture obtained in step ii) with a fatty acid ester obtained from esterified vegetable oil.

According to another variant, it is also possible that all or part of the fatty acid ester is combined with the pre-heated aggregates, then the construction materials are added to this mixture, before the mixing operation of the bituminous mixture, which is to say, in a separate step. According to this other variant of the process according to an embodiment of the invention, the process comprises the following steps:
i) reducing the size of the construction materials comprising bitumen;
ii) combining the pre-heated aggregates with a fatty acid ester obtained from esterified vegetable oil;
iii) combining the mix obtained in step ii) with the construction materials.

The hot mixture obtained according to the process of an embodiment of the invention, whatever the variants of the process, is transported to the jobsite and spread, then compacted on a road which is being made or being repaired.

It is be possible that steps (ii) and (iii) of the process according to an embodiment of the invention, including the process according to its variants, are carried out simultaneously.

It is also possible that the order of the steps of the process according to an embodiment of the invention or its variants, is reversed.

The process according to an embodiment of the invention may be a process to manufacture roads or to repair roads comprising the steps (i), (ii) and (iii), previously described.

An embodiment of the invention also relates to a use of a fatty acid ester obtained from esterified vegetable soybean oil to recycle bitumen in construction materials and to manufacture roads or repair roads. In an embodiment the construction material is shingles, aged shingle or waste (defective) shingle.

In an embodiment, the use makes it possible to recycle bitumen in shingles.

The following examples are provided for the invention for illustrative and non-limiting purposes.

### EXAMPLES

### Raw Materials:

The shingles come from Lafarge Canada Inc. They correspond to defective and non-defective production waste.

Sand n° 1 has a river origin, particle size fraction: 0/4 mm from the Petite Craz quarry at Saint Bonnet (France).

Sand n° 2 has a eruptive origin, particle size fraction: 0/4 mm from the Tertre quarry at Chazé-Henry (France).

The 4/6 aggregates have an eruptive origin, particle size fraction: 4/6 mm. They come from the Tertre quarry at Chazé-Henry (France).

The 6/14 aggregates have an eruptive origin, particle size fraction: 6/14. They come the Tertre quarry at Chazé-Henry (France).

The 10/14 aggregates have an eruptive origin, particle size fraction: 10/14 mm. They come from the Tertre quarry at Chazé-Henry (France)

The bitumen come from Lafarge Canada Inc. It is the PG 58-28 bitumen.

The comparative rejuvenating oil is an oil of petroleum origin coming from the Universal Lubricants company. It is known to reduce the viscosity of bitumens to be recycled or to increase the proportions of recycled materials in bituminous mixtures.

The fatty acid ester obtained from esterified vegetable oil comes from the MMCC Biotechnologies company, commercialized under the brand name of Biosane. It is Biosane 161313™ or Biosane BIO 2050 ED™.

### Characterisation of the Shingles:

The content of bitumen in the shingles was determined according to the European NF EN 12697-1 Standard of April 2006: Mélanges bitumineux—Méthode d'essai pour mélange hydrocarboné à chaud—Partie 1 [Bituminous mixtures.—Test method for hot hydrocarbon mixtures—Part 1].

The size distribution of the particles contained in the shingles was determined according to the European NF EN 12697-2+A1 Standard of September 2007: Mélanges bitumineux.—Méthodes d'essai pour mélange hydrocarboné à chaud—Partie 2 [Bituminous mixes—Test Methods for hot hydrocarbon mixtures—Part 2].

Table 1 below presents the results obtained in percentages by mass:

TABLE 1

| | Particle content (particle size <63 μm | Bitumen content |
|---|---|---|
| Shingles | 15.2% | 18.9% |

### EXAMPLE 1

### Production of Bituminous Mixtures

### Formula A—Asphalt Mixture According to an Embodiment of the Invention (Percentages by Mass):

| | |
|---|---|
| 4/6 aggregates: | 16.90% |
| 10/14 aggregates: | 22.18% |
| 0/4 Sand n^{o}1: | 34.57% |
| Shingles: | 26.10% |
| Biosane BIO 2050 ED: | 0.25% |

In Formula A, the quantity of shingles added to the asphalt mixture was calculated in order to obtain a final content of bitumen and Biosane of 5.18% (percentage by mass).

The shingles were mixed with the Biosane and the quantity of shingles was determined according to the target content of bitumen for the asphalt mixture (Formula A). The mixing was carried out in a Rayneri type of mixer, model R602EV from the VMI company in a vessel adapted to the volume to be treated. The Biosane was added to the shingles directly in the vessel and was slowly mixed until complete homogenisation of the two components (visual evaluation).

Once the mixing was carried out, the shingles were placed in a hermetically-closed container in order to not allow the Biosane to evaporate. This pre-treatment was carried out 14 hours before hot mixing with the aggregates in order to ensure that the contact time between the Biosane and the bitumen in the shingles was sufficient for the latter to soften. Approximately two hours before the mixing operation the shingles treated with the Biosane were pre-heated in a drying oven to about 100° C. The aggregates were heated to 140° C.

Then, the aggregates and the treated shingles were mixed in a Rayneri type of mixer from the IGM company in a heating vessel.

The aggregates and the treated shingles were mixed 5 minutes in order to obtain suitable homogeneity of the mixture and sufficient transfer of the bitumen onto the aggregates.

This experimental work showed that the produced mixture presented the aspect of standard asphalt. The aggregates were suitably coated and the mixture was sufficiently workable.

### Formula B—Control Asphalt Mixture (Percentages by Mass):

All of the bitumen in this formula proceeded from virgin bitumen. The bituminous mix was made in the following manner. The aggregates and the bitumen were heated to 145° C. Then, the aggregates and the bitumen were mixed in a Rayneri type of mixer from the IGM company in a heating vessel. The mixture was mixed for 3 minutes. A asphalt mixture was obtained.

| | |
|---|---|
| 0/4 Sand n^{o}1: | 39.83% |
| 0/4 Sand n^{o}2: | 14.22% |
| 4/6 aggregates: | 11.38% |
| 10/14 aggregates: | 14.22% |
| 6/14 aggregates: | 15.17% |
| PG 58-28 bitumen: | 5.18% |

### Formula C—Comparative Asphalt Mixture (Percentages by Mass):

The solvent in this formula was an oil of petroleum origin. The asphalt mixture was produced in the same manner as Formula A. The quantity of shingles added to the asphalt mixture in Formula C was calculated in order to obtain a final content of bitumen and rejuvenating oil of 5.18% (percentage by mass).

| | |
|---|---|
| 4/6 aggregates: | 16.90% |
| 10/14 aggregates: | 22.20% |
| 0/4 Sand n^{o}1: | 35.51% |
| Shingles: | 24.92% |
| Rejuvenating oil: | 0.47% |

### Formula D—Asphalt Mixture According to an Embodiment of the Invention (Percentages by Mass):

The asphalt mixture was produced in the same manner as Formula A. The quantity of shingles added to the asphalt mixturein Formula D was calculated in order to obtain a final content of bitumen and Biosane of 5.18% (percentage by mass).

| | |
|---|---|
| 4/6 aggregates: | 16.90% |
| 10/14 aggregates: | 22.20% |
| 0/4 Sand n^{o}1: | 35.51% |
| Shingles: | 24.92% |
| Biosane 161313: | 0.47% |

### EXAMPLE 2

### Rutting Resistance

Tests were carried out to determine the rutting resistance of the bituminous mixtures according to Formulae A and B. The tests were carried out according to the European NF EN 12697-22 Standard of June 2004. The results are given in Tables 2 and 3 below.

TABLE 2
Rutting results: Formula A

| | Rutting (%) | | |
|---|---|---|---|
| Number | | | AVERAGE of the 2 |
| of cycles | Test n^{o} 1 | Test n^{o} 2 | tests |
| 1000 | 0.60 | 0.39 | 0.49 |
| 3000 | 0.69 | 0.65 | 0.67 |
| 10000 | 1.20 | 0.99 | 1.09 |
| 30000 | 1.55 | 1.44 | 1.49 |

TABLE 3
Rutting results: Formula B

| | Rutting (%) | | |
|---|---|---|---|
| Number | | | AVERAGE of the 2 |
| of cycles | Test n^{o} 1 | Test n^{o} 2 | tests |
| 1000 | 2.67 | 3.09 | 2.88 |
| 3000 | 3.76 | 4.27 | 4.02 |
| 10000 | 5.89 | 6.41 | 6.15 |
| 30000 | 8.24 | 9.61 | 8.93 |

The deformation generated by 30 000 cycles at 60° C. was 1.49% for Formula A according to the invention and 8.93% for the control, Formula B. This very low value for Formula A reflects excellent rutting resistance for the tested mix.

### EXAMPLE 3

### Cracking Resistance at Low Temperature

Cracking resistance at low temperature was determined by a Thermal Stress Restrained Specimen Test (TSRST) on bituminous asphalt.

Three materials were tested according to the AASHTO TP10 Standard, reapproved in 1996, except for the dimensions of the specimens. The dimension of the tested specimens were the following:

Length: 150 mm

Diameter: 72 mm

(instead of 250 mm and 60 mm respectively according to the standard).

The results of the TSRST test are summarized in the Table 4:

TABLE 4

| TSRST tests | T_{failure} (° C.) | Σ_{failure} (MPa) |
|---|---|---|
| Formula C | 1.2 | 0.63 |
| Formula A | −4.9 | 1.36 |
| Formula D | −15.5 | 1.31 |

The results show that Formulae A and D according to an embodiment of the invention are significantly better than Formula C. The bases of solvent with a vegetable origin in Formulae A and D according to the invention, (BIOSANE 2050ED) and (Biosane 161313) gave significantly better results than the base of solvent with a petroleum origin in Formula C. The asphalt mixture according to Formula C cracked at 1.2° C. while the asphalt mixture according to Formula A resisted until −4.9° C. and the asphalt mixture according to Formula D resisted until −15.5° C.

What is claimed is:

1. A asphalt mixture comprising:
a crushed waste construction material including bitumen and a non-bitumen material; and
a fatty acid ester, which is obtained from esterified vegetable oil.

2. The mixture according to claim 1, wherein all the bitumen of said waste construction material comes from shingles.

3. The mixture according to claim 1, wherein the shingles are previously used shingles and/or defective shingles.

4. The mixture according to claim 1, devoid of virgin bitumen.

5. The mixture according to claim 1, wherein the fatty acid ester, is obtained from esterified soybean oil.

6. The mixture according to claim 1, comprising pre-heated aggregates.

7. A process for production of a asphalt mixture comprising:
i) reducing a size of a waste construction material comprising bitumen;
ii) combining the construction material with a fatty acid ester obtained from esterified vegetable oil;
iii) combining the mixture obtained in step ii) with pre-heated aggregates.

8. The process according to claim 7, implemented at a temperature less than or equal to 145° C.

9. The process according to claim 7, wherein the waste construction material comprises a non-bitumen material and wherein the pre-heated aggregates are combined with the waste construction material comprising bitumen and the non-bitumen material and the fatty acid ester.

10. The process according to claim 7, wherein the waste construction material is a waste of a construction product originating from a first location; and wherein the asphalt mixture is to be applied to a second location different from the first location to form an asphalt product that is different from the construction product.

11. The process according to claim 10, wherein the asphalt product is a portion of a road.

12. The method according to claim 7, wherein the construction material is a shingle.

13. A method comprising:
preparing an asphalt mixture by mixing at least a waste construction material comprising bitumen and a non-bitumen material with a fatty acid ester, which is obtained from esterified vegetable oil, wherein the waste construction material is a waste of a construction product originating from a first location; and
applying the asphalt mixture to a second location different from the first location to form an asphalt product that is different from the construction product.

14. The method according to claim 13, wherein the construction product is a shingle and the asphalt product is a road.
